(19) United States
(12) Patent Application Publication
(10) Pub. No.: US 2002/0120847 A1
(43) Pub. Date: Aug. 29, 2002

(54) Authentication method and data transmission system

(75) Inventor: Franciscus Lucas Antonius Johannes Kamperman, Eindhoven (NL)

Correspondence Address: Michael E. Marion, U.S Philips Corporation, Intellectual Property Department, 580 White Plains Road, Tarrytown, NY, 10591, US

(73) Assignee: Koninklijke Philips Electronics N.V.

(21) Appl. No.: 10/056,097

(22) Filed: Jan. 24, 2002

(30) Foreign Application Priority Data
Feb. 23, 2001 (EP) 01200670.6

(51) Int. Cl. H04L 9/00

(52) U.S. Cl. 713/170

(57) ABSTRACT

The invention relates to a method for authenticating a first unit to a second unit and, in particular, to a method for transmitting data securely over a transmission channel from a security unit to an application unit. Known data transmission methods and systems use a revocation list stored in a security unit, e.g. in a CD drive, listing identifiers of revoked application units. In order to provide an environment for secure transmission of encrypted data and/or keys where the data and/or the keys are protected against copying, hacking and other misuse and which requires only a minimum storage capacity in the security unit a method for authenticating a first unit to a second unit is proposed according to the invention comprising the steps of:

a) exchanging authentication data between said first unit and said second unit, said authentication data being retrieved from an authorization list comprising a list identifier, and

b) checking the authenticity of the authorization list and the origin of the authentication data from a valid authorization list.

The invention relates to a method for authenticating a first unit to a second unit and, in particular, to a method for transmitting data securely over a transmission channel from a security unit to an application unit. Further, the invention relates to a corresponding data transmission system and to corresponding data transmission apparatus.

For the protection of digital data from copying and/or other misuse when these data are transmitted between two units, e.g. a security unit and an application unit for data processing, a secure transmission channel must be employed. In particular, if data are to be transmitted to an application unit which is part of a personal computer (PC) such a protection is required since a PC is an insecure environment due to its open nature. Mainly interfaces and software applications in a PC are insecure. Supposed tamper resistant implementations for PC software application are employed and under development , typically for digital rights management systems, but from the many hacks on the software of copy protection systems for CD-ROMs it can be seen that the PC environment is vulnerable to attacks on security. This vulnerability has to be taken into account when linking more closed and more secure, and often difficult to renew, consumer electronic systems to PC applications, e.g. to enable playback of content which is stored on data carriers, downloaded from the internet or received via a communication line on PCs. Examples of closed systems are Pay-TV conditional access systems and super audio CD (SACD).

A method for protecting digital content from copying and/or other misuse as it is transferred between devices over insecure links is known from U.S. Pat. No. 5,949,877. The known method includes authenticating that both a content source and a content sink are compliant devices, establishing a secure control channel between the content source and the content sink, establishing a secure content channel, providing content keys, and transferring content. When setting up the secure channel with mutual authentication a check is made against a revocation list to revoke hacked, previously compliant devices and thus to protect the digital content from misuse. In a system where data stored on a data carrier like a CD or a DVD shall be read by an appropriate reading unit and thereafter transmitted to the application unit for processing or playback of these data the revocation list for application units must be stored in the reading unit, e.g. a disc drive installed in a PC. Since the revocation list includes a list of all non-compliant devices and/or PC applications that should be revoked it is updated from time to time increasing its length. It therefore requires an amount of expensive memory space in the reading unit which increases the costs of such reading units, e.g. consumer electronic devices like disc drives. If for cost reasons revocation lists are kept small their usefulness will be limited.

It is therefore an object of the present invention to provide a method for authentication and, more particular, a method, a data transmission system and a data transmission apparatus for transmitting data securely over a transmission channel which overcome the above mentioned problems, in particular, wherein no revocation list is required and wherein no additional memory space is required for storing such a revocation list in consumer electronic devices.

This object is achieved by a method for authentication according to claim 1 comprising the steps of:

a) exchanging authentication data between said first unit and said second unit, said authentication data being retrieved from an authorisation list comprising a list identifier, and

b) checking the authenticity of the authorisation list and the origin of the authentication data from a valid authorisation list.

The invention is based on the idea to use an authorisation list instead of using a revocation list. Said authorisation list containing authentication data comprises a list of all authorised first units. The authentication data are taken from said authorisation list and are used according to the invention for checking if the first unit to which, according to certain embodiments, data shall be transmitted over a transmission channel is an authorised first unit or if an authorised application is comprised therein or not. If the check of the authenticity of the authorisation list is positive, i.e. if the first unit is listed in the authorisation list or, in other words, if the authentication data give a positive result, another check for the validity of the authentication data can be made. Therein the origin of the authentication is checked, i.e. if the authentication data come from a valid authorisation list.

If all checks are successful a secure authenticated channel between the first and the second unit can be accomplished. This channel can be used to transmit any kind of data from the second unit to the first unit, i.e. it can be used to transmit encrypted content read from a data carrier or to exchange encryption and decryption keys for encrypting and decrypting content. Thus, according to the invention, it is determined if the first unit contains an application which is authorised. If it is, it is thereafter easy to set up a secure channel between the units.

According to the invention no revocation list is used. Further, the authorisation list can easily be stored in a PC as current PCs contain hard discs with large storage capacity so that the length of the authorisation list can grow without incurring any further costs for providing additional memory. The invention is particularly useful if the characteristics of the first and the second unit are not balanced, i.e. if one unit has more storage capacity then the other, and to a certain extent, if one unit is considered more secure than the other.

According to a preferred embodiment the step of authentication of the first unit is terminated if the step of checking fails. Thus it can be easily prevented that data are transmitted over an insecure transmission channel or to an insecure unit where the risk that data are hacked is high.

According to another embodiment said first unit comprises an application unit including or running an application making use of data and said second unit comprises a security unit, e.g. for reading or receiving data and for sending said data, preferably after encryption, to said application unit.

In the preferred embodiment of claim 5 a certified application list is used comprising certified public keys of application units. For performing the check if the application unit is included in the certified application list the public key of the application unit and an identifier of the certified application list is transmitted from the application unit to the security unit. Therein the identifier is used to check if the public key of the application unit is taken from an authorised and valid version of the certified application list. The public key of the application unit is used to check if the application unit comprises a certified application so that data can be transmitted securely to the application unit. By such method data transmitted from the security unit to the application unit are reliably protected from any misuse during the transmission to the application unit. To improve security of data transmission, the data can be encrypted before transmission.

According to a further preferred embodiment of the invention a certified security unit revocation list is additionally used by the application unit against which the public key of the security unit is checked before the data transmission is started. For performing this check the public key of the security unit is transmitted to the application unit. It can thus be checked by the application unit if the security unit is a compliant device and not revoked which increases the overall security of the data transmission. Preferably public keys which are certified by a certification unit are used.

In another preferred embodiment the public keys are checked by use of a public key of a certification unit provided by the certification unit to the security unit and the application unit. The certification unit is part of a certification authority providing and updating the certified application list and the certified security unit revocation list. The certification unit further generates pairs of secret and (certified) public keys for application units as well as for security units and authorises these units. On request it also provides a public key according to the invention for checking the security unit and the application unit against the certified application list or the certified security unit revocation list, respectively. Typically, the same public keys of the certification unit are used to check the public key of certain units or devices.

There can be many ways according to the invention for distributing the certified application list. Preferred options for this distribution are the distribution together with the data to be transmitted over the secure data transmission channel, together with data carriers on which such data are stored or together with application units or with applications, e.g. computer programs or any other kind of software.

The identifier of the certified application list is used according to another embodiment of the invention to identify the current version of the valid certified application list. This identifier can simply be a version number of the certified application list. By this identifier it can be made sure that only keys from the current version of the certified application lists are taken.

There are also many ways of distributing the identifier of the certified application list. Preferred ways are the distribution together with data carriers, i.e. every data carrier contains this identifier, or over a transmission channel from security units, application units or a certification unit. By these different ways of distributing the identifier it can be made sure that the identifier is distributed as wide as possible in order to identify the current valid version of the certified application list. Preferably, the certified application list and the identifier thereof are distributed simultaneously.

The object is also achieved by a data transmission system according to claim 12 comprising a first unit, preferably comprising an application unit, and a second unit, preferably comprising a security unit. Such data transmission system further comprises according to an embodiment a certification unit. According to still a further embodiment and in practical implementations the data transmission system comprises a computer comprising a reading unit for reading a data carrier storing the data to be transmitted. In this embodiment the application unit is embodied as software which runs on the computer. The security unit being also part of the computer is connected to or arranged in the reading unit and is provided for decrypting and re-encrypting the data read from the data carrier. In this embodiment the invention is particularly useful since the computer is, in general, an insecure environment as described above.

Still further, the object is also achieved by a data transmission apparatus according to claim 16 comprising an application unit and a security unit which data transmission apparatus can be a personal computer. The data transmission system and the data transmission apparatus can be developed further and can have further embodiments which are similar or identical to those which have been described above with reference to the method according to claim 1.

The invention will now be described in more detail with reference to the drawings, in which

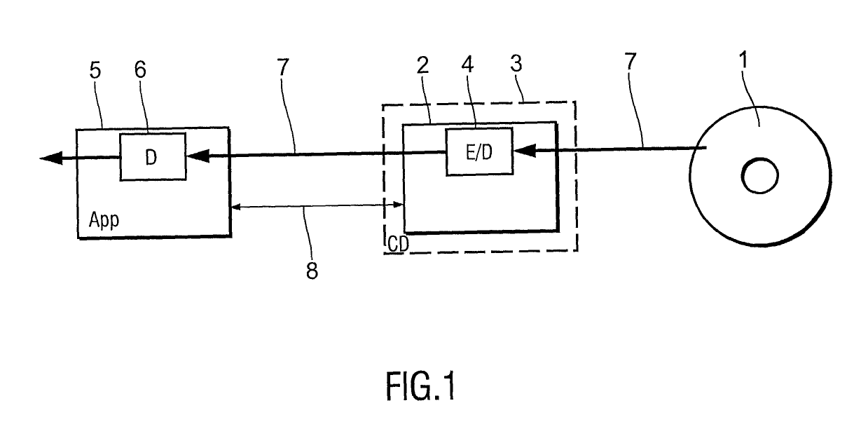

FIG. 1 shows a block diagram of a data transmission system according to the invention,

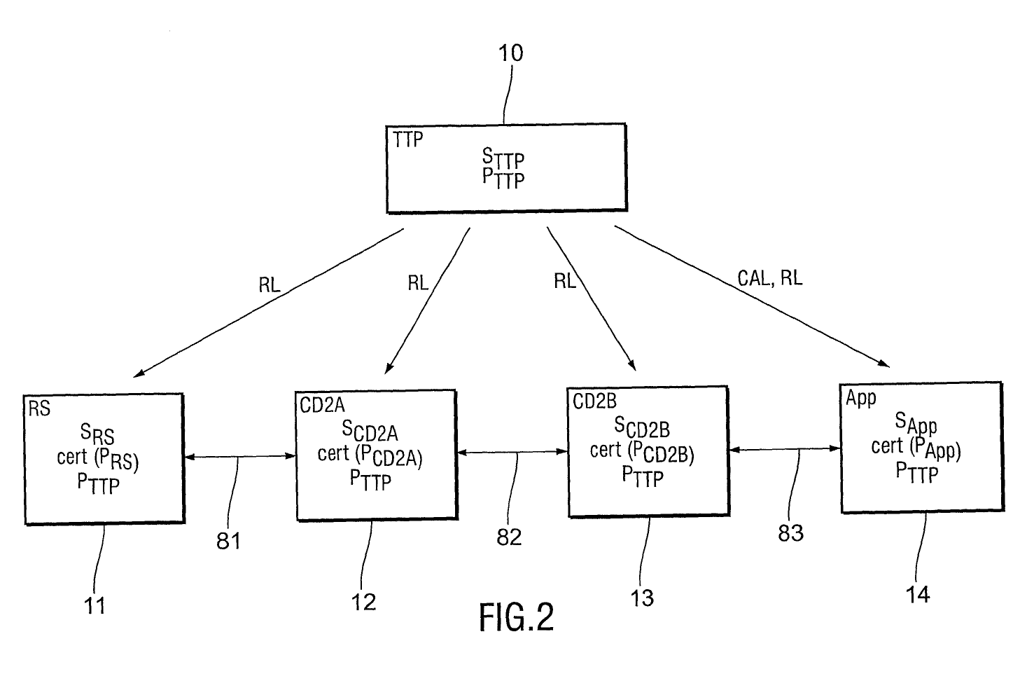

FIG. 2 shows a block diagram of another embodiment of a data transmission system according to the invention,

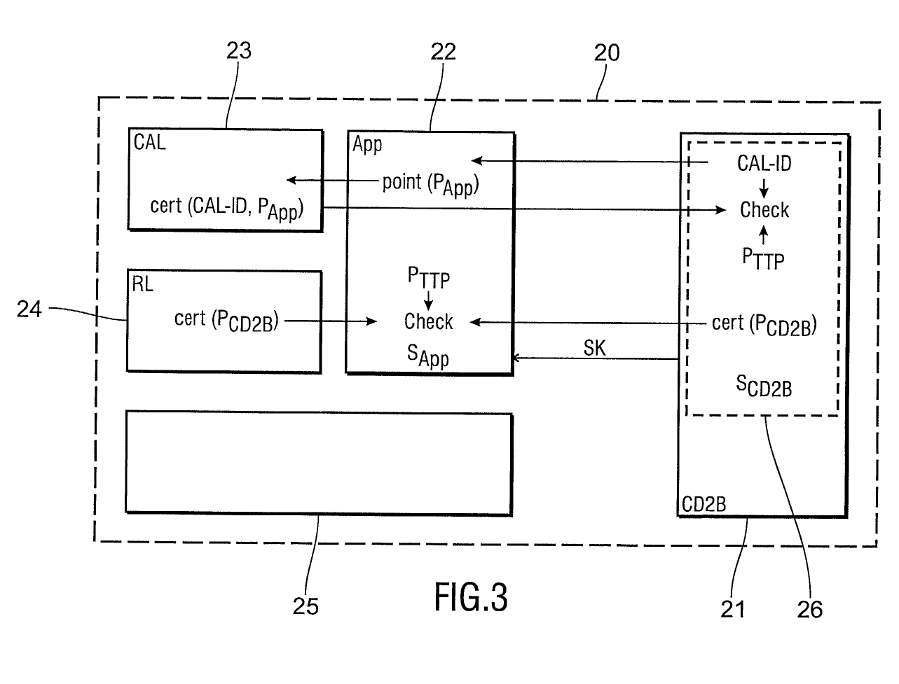

FIG. 3 shows a block diagram of a data transmission apparatus according to the invention and

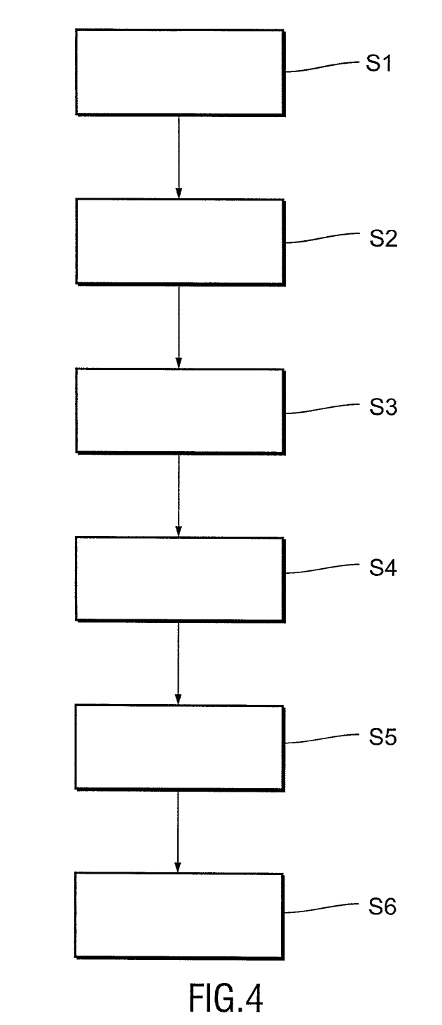

FIG. 4 shows the steps of the data transmission method according to the invention.

A simplified block diagram of a data transmission system according to the invention is shown in FIG. 1. In this system content is stored on a data carrier 1, e.g. a CD or a DVD, encrypted with a key. The encrypted content is at first input to a security unit 2 of a reading unit 3, e.g. a CD drive, for playback. The security unit 2 is implemented in hardware and located in the CD drive 3 for security reasons, but can be any unit that is considered secure which could be even software/firmware or a smart card processor. In the security unit the content is decrypted by a first key and re-encrypted with a new random key in the encryption unit 4 and then transferred in this encrypted form to an application unit 5. In the application unit 5 the content is again decrypted by a decryption unit 6 and thereafter forwarded to a playback unit (not shown) for playback of the content now being in the clear.

The decryption and re-encryption in the security unit 2 disconnects the CD drive security from the application unit security, i.e. a hack on the application software run in the application unit 5 will not effect the security of the CD drive 3. If the key used to encrypt the content is discovered from the application unit, the key used to encrypt the content on the CD is still secret. Besides it has no use to distribute the key discovered to others as it has been diversified by the re-encryption and so nobody else can use it.

For the transmission of the encrypted content from the data carrier 1 to the reading unit 3 and from the reading unit 3 to the application unit 5 data channels 7 are used. The key used for re-encrypting the content in the encryption unit 4 and also for decrypting the content later in the decryption unit 6 is transferred from the security unit 2 to the application unit 5 by use of a secure authenticated channel (SAC) 8 which complies with the following requirements: the SAC 8 enables a secure transfer of keys between the security unit 2 and the application unit 5. It further provides for a revocation and a renewability mechanism for PC applications. Optionally, it also provides for a revocation mechanism for security units. Preferably, a minimum storage and processing is required for the security unit 2. A secure authenticated channel which satisfies these requirements and which is accomplished according to the invention will be described in more detail below.

An even more general layout of a data transmission system according to the invention is shown in FIG. 2. Therein a certification unit 10, which may also be referred to as trusted third party (TTP) (also often called Certification Authority) is shown. Said certification unit 10 issues key pairs of private (secret) keys S and public keys P and also has its own private key S_{TTP} and its own public key P_{TTP}. The certification unit 10 further certifies public keys of right servers (RS) 11, replaying and recording units 12, 13, e.g. CD drives (CDA, CDB), and application units (App) 14. Still further the certification unit 10 issues and updates certified revocation lists RL for reading units 12, 13, and possibly rights servers 11 as well as application units 14 to indicate revoked non-compliant units. Still further the certification unit 10 issues and updates certified application lists (CAL) to indicate authorized PC applications.

As can be seen in FIG. 2 secure authenticated channels are required or can be used between different units. A first SAC 81 is required to transfer rights from the rights server 11 to the first CD drive 12. Another SAC 82 is required to transfer keys and content from the first CD drive 12 to the second CD drive 13. A third SAC 83 is required to transfer keys and encrypted content from the CD drive 13 to the application unit 14.

The first two secure authenticated channels 81, 82 do only require a revocation list RL from the certification unit 10 to accomplish a secure transmission of keys and/or data between the connected units. For installing the secure authenticated channels 81, 82 each of the connected units 11, 12, 13 is provided with the public key P_{TTP} of the certification unit 10 and with its own unique private key S_{RS}, S_{CDA}, S_{CDB} and with its own certified unique public key cert(P_{RS}), cert(P_{CDA}), cert(P_{CDB}). It shall be noted that the certification of the public keys is done by the certification unit 10.

In contrast the third secure authenticated channel 83 between the CD drive 13 and the application unit 14 does primarily require a certified application list CAL. The application unit 14 does also include the public key P_{TTP} of the certification unit 10, its unique private key S_{App} and its certified unique public key cert(P_{App}). Additionally, also a revocation list RL can be used for the transmission of data and/or keys from the CD drive 13 to the application unit 14 over SAC 83. The steps for installing the SAC 83 will be explained in more detail with reference to FIGS. 3 and 4.

FIG. 3 shows the layout of a data transmission apparatus according to the invention. The data transmission apparatus can be implemented in a personal computer 20 comprising a CD drive 21 as reading unit, an application unit 22, a certified application list 23, a revocation list 24 and other PC hardware and PC units 25. According to the invention a secure authenticated channel for the transmission of keys and encrypted content read by the CD drive 21 from a data carrier to the application unit 22 can be established.

In a first step (S1 in FIG. 4) the application unit 22 retrieves from the security unit 26 of the CD drive 21 an identifier CAL-ID, e.g. a number, of the certified application list CAL. By use of a pointer point(P_{App}) pointing to the public key of the application in the certified application list 23 the application unit 22 retrieves its public key P_{App} from the certified application list 23. The application itself could also contain the certified public key, but using the CAL is better in case of updates, and the application anyhow has to prove that the public key is on the list. The application unit then sends the public key P_{App} together with the identifier CAL-ID, which is concatenated with the public key and then certified, identifying this certified application list to a security unit 26 in the second step (S2). Thereafter the security unit 26 checks the public key P_{App} of the application in the next step (S3) by use of the public key P_{TTP} of the certification unit which the security unit 26 retrieved therefrom. At the same time the security unit 26 checks the validity of the CAL-identifier already present in the security unit 26 by use of the CAL-identifier received from the application unit. It is thus made sure that the public key is part of the certified application list 23 and that the certified application list is also the current and valid version.

As optional security measures the security unit 26 sends it public key P_{CDB} to the application unit 22 in a forth step (S4) where the application unit checks this public key P_{CDB} against a revocation list (RL) 24, i.e. checks if the public key P_{CDB} of the security unit 26 is not revoked (step S5). Also for this check the public key P_{TTP} of the certification unit is used. The certified security unit revocation list 24 is a list of revoked security units and may contain sequence numbers to identify updates of the list.

If the checking step S3 and the optional checking step S5 both give a positive result both public keys P_{CDB} and P_{App} have been exchanged and a session key SK can now be exchanged in a final step (S6) to establish a secure authenticated channel between the security unit 26 or the CD drive 21, respectively, and the application unit 22. Content read by the CD drive 21 from a data carrier can now be transmitted in encrypted form to the application unit 22 and is thus protected from being copied or misused in any other way. The secure authenticated channel used in this embodiment is a control SAC, i.e. it is used to transmit key, rights, etc. The content itself was already encrypted from the disc or through re-encryption.

According to the invention only a minimum storage space is required in the security unit 26, i.e. only the CAL identifier, e.g. the CAL number. Each application running on the PC 26 may have diversified keys. The certified application list may also be implemented in a hierarchical form and may extend the described scheme.

The certified application list only needs to be transferred to the PC, in particular to the application unit of the PC running authorized applications. If a security unit connects with a PC, the authorized application takes care of transferring the relevant item from the certified application list to the security unit. In general, there are various options to distribute the certified application list: it can be downloaded from the internet, sent together with content when downloading it, distributed together with content on read-only data carriers, distributed together with authorized applications, distributed on data carriers attached to computer magazines or recordable data carriers copied from other persons. Further ways of distributing the certified application lists are also possible.

The identifier of the certified application list, e.g. the version number, needs to be transferred to the security unit in any way. Firstly, this can be done via data carriers, every data carrier should contain this number. Read-only data carriers are used for initial distribution, thereafter recorders will cache this number and write it onto recordable data carriers. Secondly, the identifier will be transferred to a security unit during a transaction with a server, e.g. for obtaining rights, or will be sent together with an entitlement in a CA system. Thirdly, the identifier will be transferred to a security unit during a transaction with another security unit. Forthly, this identifier will be transferred by PC applications offering a certificate with a CAL-identifier to a security unit for initiation of data transfer.

It is also advantageous to transmit the certified application list and the associated list identifier simultaneously. This has the advantage that if the identifier is updated in the reading unit, the application list in the PC can also be updated, ensuring continuously smooth system operation. If only the list identifier in the reading unit is updated, authentication of the application unit may fail until the certified application list is also updated.

According to the present invention the certified application list can be a list, but it can also consist of separate parts or data fields per application. The authenticity per part can be checked just as if that part is valid. Therefore each part may contain a digital signature and every part may also contain the list identifier. This has the advantage that only the relevant part needs to be transferred between a first and a second unit.

In contrast to the known system the transmission system and method according to the invention use an authorization list instead of a revocation list. This has the advantage that the reading unit, e.g. the CD drive, does not need to store a revocation list and therefore does not need expensive memory. The authorization list can easily be stored in the PC as current PCs contain hard discs with large storage capacity.

1. Method for authenticating a first unit to a second unit comprising the steps of:
a) exchanging authentication data between said first unit and said second unit, said authentication data being retrieved from an authorisation list comprising a list identifier, and
b) checking the authenticity of the authorisation list and the origin of the authentication data from a valid authorisation list.

2. Method according to claim 1, wherein authentication of said first unit is terminated if said step of checking fails.

3. Method according to claim 1, wherein said first unit comprises an application unit including an application and said second unit comprises a security unit.

4. Method according to claim 3, wherein said authorisation list comprises a certified application list comprising information about authorised applications.

5. Method according to claim 4, wherein in said step a) a certified public key of said application unit retrieved from said certified application list and a list identifier of said certified application list is transmitted from said application unit to said security unit, wherein in said step b) said certified public key of said application unit and said list identifier of said certified application list is checked by said security unit.

6. Method according to claim 5, further comprising the steps of
b1) transmitting a certified public key of said security unit from said security unit to said application unit, and
b2) checking said public key of said security unit by said application unit against a certified security unit revocation list.

7. Method according to claim 6, wherein said public keys are checked by use of a public key of a certification unit provided by said certification unit to said security unit and said application unit.

8. Method according to claim 5, wherein said certified application list is provided and updated by a certification unit.

9. Method according to claim 1 or 8, wherein said list identifier is distributed together with data carriers or from any of said first unit, second unit or said certification unit.

10. Method for transmitting data securely over a transmission channel from a second unit to a first unit comprising a method for authenticating said first unit to said second unit according to claim 1, further comprising the steps of:
c) encrypting data to be transmitted using an encryption key by said second unit, and
d) transmitting said encryption key and the encrypted data from said second unit to said first unit or determining said encryption key by said first and said second unit.

11. Method according to claim 10, wherein said authorisation list is distributed together with said data to be transmitted, with data carriers, with application units or applications.

12. Data transmission system for transmitting data securely over a transmission channel comprising:
a) a first unit for transmitting authentication data from said first unit to said second unit, said authentication data being retrieved from an authorisation list comprising a list identifier,
b) a second unit for checking the authenticity of the authorisation list and the origin of the authentication data from a valid authorisation list and for transmitting said data over a transmission channel from said second unit to said first unit.

13. Data transmission system according to claim 12, wherein the second unit is provided for encrypting data to be transmitted using an encryption key, and for transmitting said encryption key and said encrypted data from said second unit to said first unit or for determining said encryption key by said first and said second unit.

14. Data transmission system according to claim 12, further comprising a certification unit for providing a public key of said certification unit for checking said authentication data and for providing and updating said authorisation list.

15. Data transmission system according to claim 12, further comprising a computer comprising a reading unit for reading a data carrier storing the data to be transmitted, wherein said first unit is part of said computer provided for running an application and wherein said second unit is part of said computer connected to or arranged in the reading unit provided for decrypting and re-encrypting data read from said data carrier.

16. Data transmission apparatus for transmitting data securely over a transmission channel comprising:
a) a first unit for transmitting authentication data from said first unit to said second unit, said authentication data being retrieved from an authorisation list comprising a list identifier,
b) a second unit for checking the authenticity of the authorisation list and the origin of the authentication data from a valid authorisation list, for encrypting data to be transmitted using an encryption key, and for transmitting said encryption key and said encrypted data from said second unit to said first unit or for determining an encryption key by said first and said second unit.
